(19) United States
(12) Patent Application Publication
(10) Pub. No.: US 2004/0144903 A1
(43) Pub. Date: Jul. 29, 2004

(54) Apparatus for holding a vial

(76) Inventors: Julian H. Cherubini, Boston, MA (US); Ray G. Dechoretz, Melrose, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/350,441

(22) Filed: Jan. 23, 2003

(51) Int. Cl. F16M 11/00

(52) U.S. Cl. 248/231.71; 248/176.1

(57) ABSTRACT

A method and apparatus for holding vials for use with a hypodermic needle. The apparatus includes a base adapted to be mounted on a surface, and a holding portion having a plurality of elongated slots for receiving and holding necks of vials in a snap fitting relationship. The apparatus also includes a clamp attached to the base for removably clamping the base to a surface, with the clamp being adjustable for any desired surface. The snap fitting relationship is provided by outwardly flexing arms located on each side of the elongated slot and by a pair of nodes or shoulders located on the elongated slot. The holding portion can be rotated with respect to the base to achieve any desired angle and position for easily accessing the vial cap with a hypodermic needle.

### FIELD OF THE INVENTION

This invention relates generally to devices that hold medical vials, and in particular to removably securable holders that are capable of holding one or more vials having different lengths and/or diameters.

### BACKGROUND OF THE INVENTION

When a doctor or a nurse is performing an injection, a hypodermic needle generally is used to withdraw medication from a vial. This vial must be gripped or held stationary in some fashion during this procedure. If the injection is performed in a sterile environment, the person inserting the needle into the vial cannot grip the vial because the exterior of the vial is usually not sterilized and that person would experience a loss of sterility. Either a non-sterilized assistant or a vial holder is necessary to assist in this operation. Drawbacks of an assistant holding the vial include the risk that the assistant will accidentally be stuck with the needle, and the added cost/time required for two people to provide an injection. Vial holders are preferred since they avoid the foregoing drawbacks. Vial holders also reduce the risk of drug mix-ups because only one person is involved in the process of locating the correct vial and injecting the needle. Examples of existing vial holders are shown in U.S. Pat. Nos. 4,278,225; 5,704,495; and 2,677,372.

U.S. Pat. No. 4,278,225 discloses an inclined vial holder that can be secured to the wall. One disadvantage of the device disclosed in this patent is that the vial holder must be fixed in one position. Another drawback is that this device may support vials of only one predetermined size, since the vial is secured by a clamping force between two surfaces spaced by a predetermined distance.

U.S. Pat. No. 5,704,495 also discloses a vial holder that can be affixed to a wall. The holder of this patent allows for different vial lengths, but all vials must be of a predetermined length, based on the presized boxed spacers that decrease the distance between the upper and lower shelf.

U.S. Pat. No. 2,677,372 discloses a bottle holder that is also affixed to the wall. While the device of this patent can hold bottles of varying lengths, it can only hold one bottle at a time and it can only hold bottles of a certain diameter. Also, this device grips bottles using a device that is difficult to operate.

It is therefore desirable to have a device that can hold vials of varying lengths and diameters at the same time and from which a vial may be quickly secured and easily removed. It is also desirable to have a vial holder that can be removably affixed to a variety of different surfaces for portability.

### SUMMARY OF THE INVENTION

The present invention relates to a holder for removably securing a vial and a method for use thereof. The present invention typically is used in a sterile environment where the person who is injecting a needle into the vial cannot touch the unsterilized vial.

One aspect of the invention relates to a vial holder that can secure one or more vials of varying lengths and diameters in one configuration. In one embodiment, the vial holder comprises a base, a holding portion which is attached to the base and which is adapted to receive a vial, and a clamp attached to the base for removably clamping the base to a surface, the clamp being adjustable for any desired surface. This clamp allows the vial holder to be secured to a variety of surfaces, such as a counter or an operating room table siderail, and to be easily removed to be affixed to another mounting surface.

In another embodiment of this invention the holding portion has at least one elongated slot for receiving and holding a neck of a vial in a “snap-fit” relationship. This “snap-fit” secures the vial into a slot which eliminates the need for a surface to support the bottom of the vial.

Another aspect of the invention relates to a method for restraining a plurality of vials, which includes the steps of providing a holder having a plurality of slots for retraining a plurality of vials of different sizes, holding each vial in a “snap-fit” relationship about the neck of the vial and clamping the holder to a desired stable support using a removable, manually operated clamp.

### BRIEF DESCRIPTION OF THE DRAWINGS

The objects, advantages and features of this invention will be more clearly appreciated from the following detailed description, when taken in conjunction with the accompanying drawings in which:

FIG. 1 is a perspective view of the apparatus of this invention for holding a vial;

FIG. 2 is a side elevation view of the apparatus of FIG. 1, illustrating the inclined position and the clamp;

FIG. 3 is a magnified view of the circled portion of FIG. 1, illustrating a slot;

FIG. 4 is a partial, perspective, schematic view showing the apparatus clamped to a mounting support;

FIG. 5 is top view of a top portion of the clamp of FIG. 4;

FIG. 6 is a perspective view of an alternative embodiment of the apparatus of FIG. 1 in which the base is rotatable with respect to the clamping device;

FIG. 7 is a side elevation view of an alternative embodiment of the apparatus of FIG. 1 in which the holding portion is secured to the clamp with projections; and

FIG. 8 is a magnified view of the circled portion of FIG. 1, illustrating the outward flex of the arms.

### DETAILED DESCRIPTION

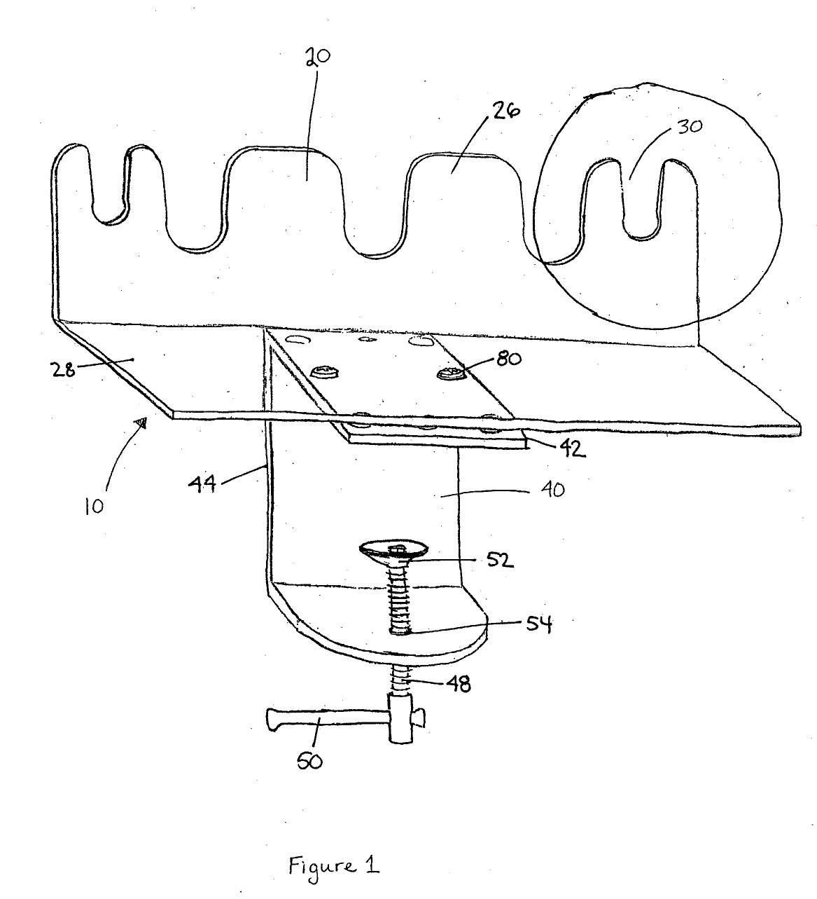

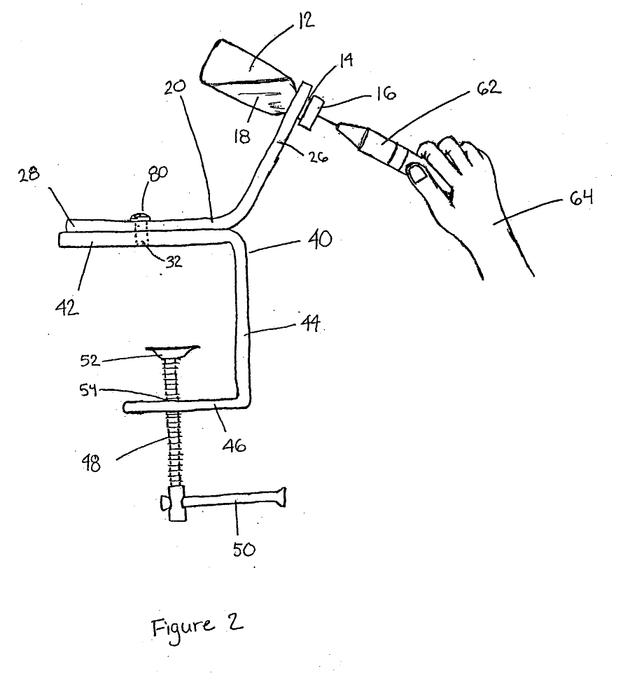

With reference now to the drawings, and more particularly to FIGS. 1 and 2 thereof, one embodiment of the apparatus 10 for holding a vial 12, will now be described. A typical vial 12 includes body 13, neck 14, a cap 16, and contains a fluid 18 within body 13. In a preferred embodiment, apparatus 10 includes a holding portion 20 attached to a clamp 40. The holding portion 20 typically includes a base 28 and a holder 26 that forms an angle with respect to base 28. Typically, base 28 is secured to clamp 40 by attachments 80, 82, which may be removable. Examples of attachments 80 and 82 include screws, or rivets inserted through a hole 32.

In one aspect, holder 26 is configured to hold a plurality of vials 12 of different sizes, as will be described. Holder 26 typically forms an angle with respect to the horizontal such that fluid in the vial 18 collects against the interior surface of the cap 16 of the vial 12. This orientation ensures that when inserted through cap 16, a needle 62 will only draw fluid 18, and not air. Therefore, the preferred angle of holder 26 with respect to base 28 depends upon the angle base 28 forms with respect to the horizontal and upon the orientation of vial 12 in holder 26. In the configuration shown in FIG. 2 in which base 28 is substantially horizontal and the body and not the cap 16 of vial 12 overlies base 28, the angle between holder 26 and base 28 typically can range from about 90° to about 180°, with a preferred angle being approximately 120°. Angles of less than 180° are preferred for ease of access to the vial cap 16, so that a hand 64 of a person is disposed at a comfortable angle when inserting the needle 62 into cap 16 of the vial. If the angle is less than about 90°, the fluid 18 might not be in engagement with cap 16 in the vicinity of the needle 62. It is understood, however, that other angles between holder 26 and base 28 could be acceptable for different configurations of holder 26 and base 28.

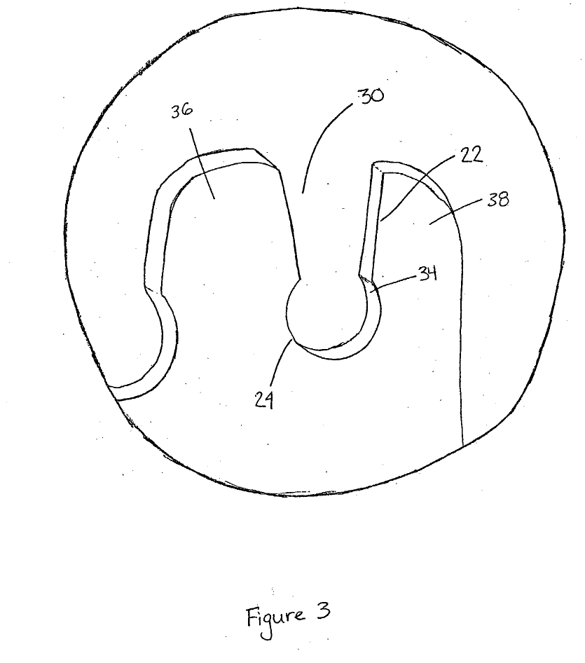

Vials 12 are held in place by vial slots 30 in holder 26, as shown in FIG. 3. Slots 30 typically have a key-hole like shape and are formed by spaced, projecting arms 36 and 38. Each slot 30 includes an opening with angled surfaces 22 that guide the vial neck 14 to a securing portion 24. Surfaces 22 are formed on arms 36 and 38 disposed on either side of slot 30. Each securing portion 24 is disposed at the end of its associated slot 30 opposite the opening and has a lower surface 31 forming a partially enclosed, generally circular configuration with a diameter substantially the same as or only slightly greater than the diameter of the neck 14 of the vial 12 to be inserted. At the entrance to the securing portion 24 there are a pair of opposed rounded nodes or shoulders 34. Shoulders 34 are formed at the junction of each surface 22 and lower surface 31, and typically are spaced a distance slightly less than the diameter of the neck 14 of a vial to be inserted. Shoulders 34 provide a “snap fit” that restrains the vial within the holder. This “snap-fit” is defined as a fastening or latching due to an abrupt return movement of arms 36 and 38 of holder 26 to a latching position after having been moved from a latching position by an applied force. For the vial neck 14 to slide past shoulders 34 into the securing portion 24, arms 36, 38 typically flex slightly outwardly away from slot 30. This flexing motion occurs due to the inherent properties of the material of the holding portion 20 and the thickness of arms 36 and 38 which permit movement of arms 36 and 38 upon the application of force, but which allow the arms to return to their original position upon the removal of force. As a vial neck 14 is pushed down slot 30 along surfaces 22 and toward the securing portion 24, further movement of neck 14 is prevented by shoulders 34. The application of a further pushing force produces an outwardly directed force on shoulders 34, pushing shoulders 34 away from one another and causing arms 36 and 38 to separate sufficiently to allow the vial neck 14 to pass between shoulders 34 and into the securing portion 24. As neck 14 passes shoulders 34 and into securing portion 24, the slot returns to its original width as arms 36 and 38 and the shoulders 34 return to their originally spaced distance. The shoulders 34 thereafter act to retain the vial 14 within the securing portion 24.

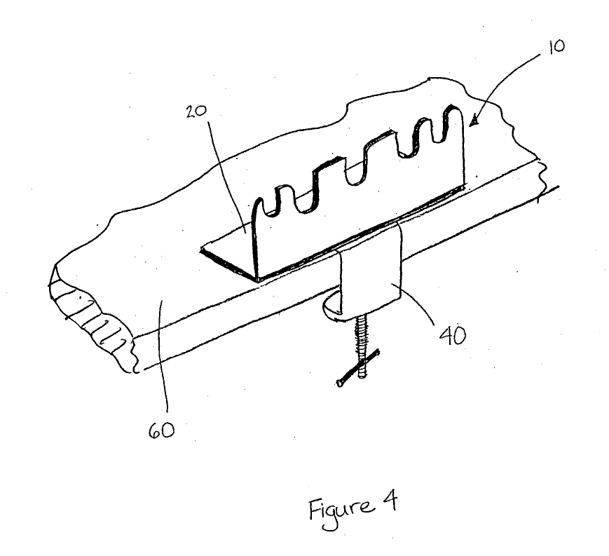

In a preferred embodiment, as shown in FIGS. 1 and 4, holder 26 contains multiple slots 30 having securing portions 24 with different diameters and shoulders 34 with different spacings to allow for different sized vial necks 14. Each slot typically is sized for use with a predetermined sized vial neck 14. This embodiment enables more than one vial of varying sizes to be accessible for use with hypodennic needles. Slots 30 typically, although not necessarily, are substantially formed in parallel.

The thickness of the material forming holder 26 typically is equal to or less than the length of neck 14 of an inserted vial 12. This “snap-fit” between the neck of the vial 14 and holder 26, and this thickness of holder 26 within portion 24, combined with the tight fit of neck 14 within securing portion 24 provide support to neck 14 and vial 12 in lateral and lengthwise directions to minimize any pivoting or lengthwise movement of vial within portion 20. This support eliminates the need for a surface to support the bottom end of the vial and allows a person to insert a needle and withdraw liquid from the vial 12 with one hand.

To remove a vial 12 form securing portion 24, an upward force is applied on vial 12 towards the opening of the slot 30. This force causes the vial neck 14 to bear against the inner surfaces of shoulders 34, which causes arms 36 and 38 to again flex outwardly, allowing release of the vial neck 14 past shoulders 34 and disengagement of the “snap-fit.”

FIGS. 2 and 4 illustrate another aspect of the invention, the adjustable clamp 40 for holding the apparatus 10 in place on a stable mounting support 60. In this aspect of the invention, one desired support 60 is the edge of a table. Support 60 could also be a door, a wall, a cabinet, an operating room side rail, an IV pole, or other like supports. Support 60 could have any shaped surface commonly found in a medical setting such as planar, curved, circular or semi-circular. In one embodiment, the clamp 40 includes a top plate 42 a side bracket 44, and a bottom plate 46. In this embodiment, a threaded rod 48 passes through a correspondingly threaded hole 54 on the bottom plate 46. At a distal end of the threaded rod 48 there may be affixed a pivotally mounted enlarged bearing member 52 that is configured to bear against the lower surface of support 60. Bearing member 52 increases the contact surface area between the threaded rod 48 and the desired mounting support 60. The proximal end of the threaded rod 48 may include a manually operable handle 50 for rotation of rod 48 to move rod 48 axially toward and away from plate 42, to clamp support 60 between member 52 and plate 42 in a known manner. Other types of known clamps (not shown) could also be used, such as a spring loaded butterfly clamp or the like that permits removal and remounting of the apparatus 10 to a desired support. Such devices permit use of the apparatus 10 of this invention in conjunction with supports 60 of different thickness as well as movement of apparatus 10 from one location or orientation to another for the convenience of the user.

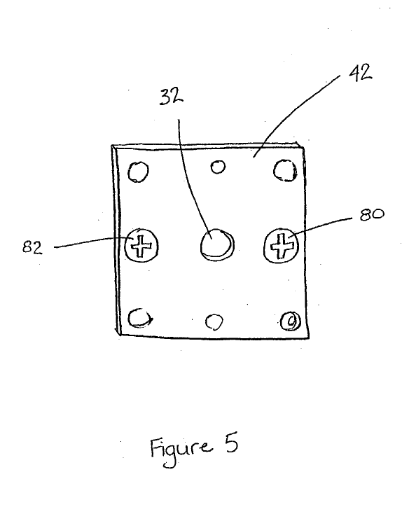

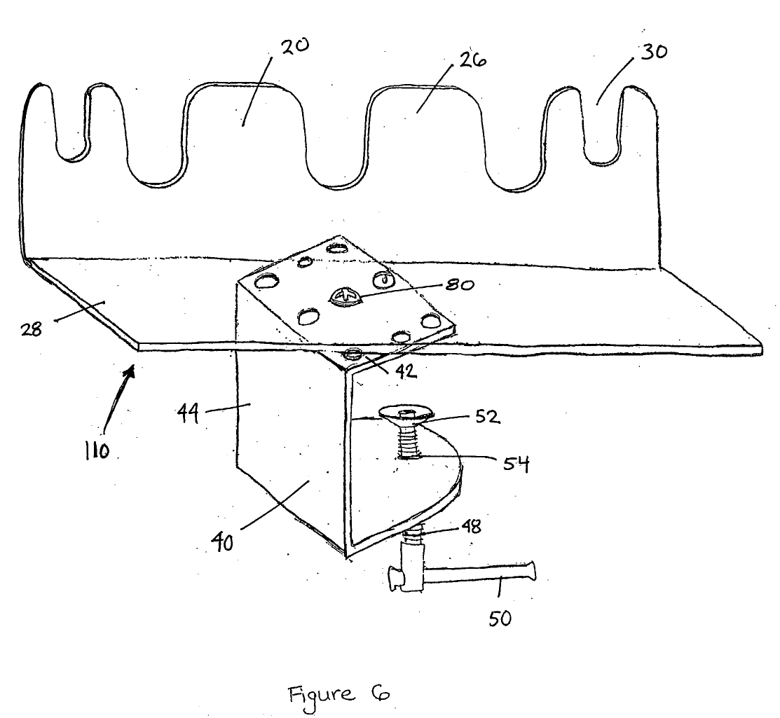

In another aspect, as shown in FIG. 5, multiple placement holes 32 may be provided in plate 42 to permit attachment of plate 42 to base 28 at different locations and in different orientations. In the embodiment shown in FIG. 5, the attachments 80, 82 preferably are two spaced screws placed in the middle holes 32 along two edges of plate 42. In other embodiments base 28 could be attached at other placement holes 32 to allow rotation or other movement of base 28 with respect to plate 42. In FIG. 6, the attachment consists of only one screw located in the center placement hole 32 of plate 42. In this alternative embodiment, the holder 26 may be rotated into a desired orientation with respect to plate 42 prior to tightening of the screw. This rotation to a desired position allows the vial caps 16 to be repositioned for the convenience of the user when the apparatus 10 is moved to a different surface. If the desired vial angle differs from a fixed angle between the base 28 and the holder 26, the orientation and position of the holding portion 20 can be altered as desired to achieve the desired vial angle by rotation of holder 26 with respect to base 28 and by adjusting the location of clamping device 40 on a support 60.

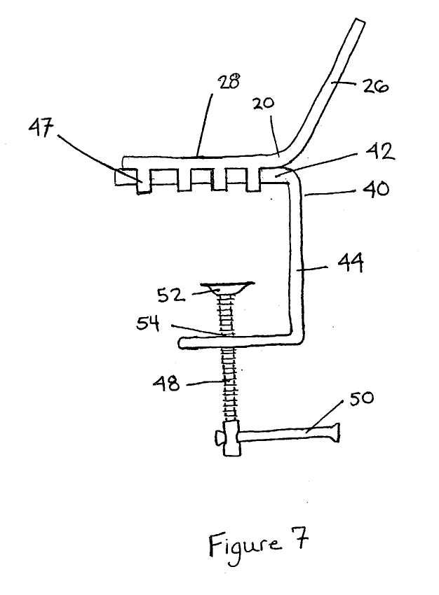

In another embodiment as shown in FIG. 7, projections 47 aligned with holes 32 in plate 42 could be provided on the underside of base 28, to minimize unwanted rotation between plate 42 and base 28. Alternatively, such projections 47 could be disposed on plate, 42 and the holes could be formed in base 28. It is understood that any form of attachment between the clamp 40 and the holding portion 20 is encompassed within the scope of this invention.

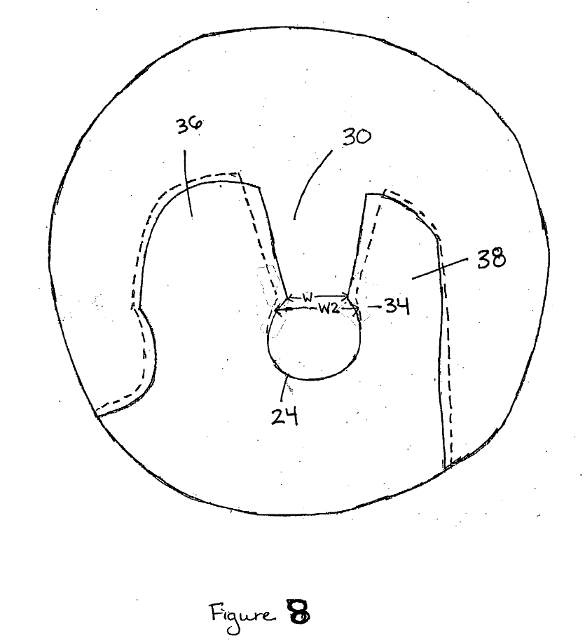

FIG. 8 illustrates the outward flex of the arms 36 and 38 which allows the vial neck 14 to slide past shoulders 34 into the “snap-fit” engagement. With no force exerted on the arms the slot distance between shoulders 34 at the entrance of the securing portion 24 is W. When a vial is inserted into the slot the vial exerts a force onto shoulders 34 causing the slot distance between shoulders 34 to increase to W2. This outward flex of the arms allows the vial to be inserted past the shoulders 34. Once the vial is within the securing portion 24, the arms flex back inwardly to retain the vial. Similarly, when the vial is disengaged from the vial holder, a force is applied to the shoulders which causes the arms to flex outwardly enabling disengagement of the “snap-fit”. Upon removal of the vial from the holder, the slot distance between shoulders 34 returns to W.

In another aspect of the invention, holder 26 may be made of a transparent material to enable the vial labels to be easily read, regardless of the placement of holder 26. An example of an acceptable material is clear Lexan® plastic.

In a further aspect, all components of the device can be made out of materials that withstand a sterilization process. In a preferred embodiment, the device is made out of plastic materials which may be injection molded or machined.

Another aspect of the invention relates to a method for restraining a plurality of vials 12 containing medications and having different sizes for withdrawal of the medications therefrom with a hypodermic needle. A holder is provided having a base 28 and a holding portion 20 attached to the base and adapted to receive a plurality of different sized vials. Each vial is secured in place in the holding portion 20 by sliding the vial neck 14 into the slot 30, past the shoulders 34 and into the securing portion 24, initiating a “snap fit” relationship. The holder is clamped to a stable support using a manually operated clamp that allows the holder to be moved to any desired location. This step may occur before or after insertion of the vials into their slots. Then, a hypodermic needle is inserted through the vial cap 16 to withdraw fluid 18. Since the vial is inserted into the holder prior to use, only one person is needed to withdraw fluid into the needle. Furthermore, using the above described method enables the person performing the injection to maintain his/her sterility.

As described above, apparatus 10 may be equipped with multiple slots for different sized vials, enabling vials of all lengths and diameters to be held at the same time. Clamp 40 permits the device to be portable and to be attached to different types of supports. The “snap-fit” relationship allows vials to be easily replaced when empty and does not limit the length of vials being held.

Modifications and improvements within the scope of this invention will occur to those skilled in the art. The above description is intended to be exemplary only. The scope of this invention is defined only by the following claims and their equivalents.

What is claimed is:

1. A device for holding a vial for use with a hypodermic needle, the device comprising:
a vial holder having a plurality of slots, each slot including a securing portion for holding a vial in a snap-fit relationship about a neck of a vial, some of said slots being larger than others of said slots, vials disposed in said slots being unrestrained other than by said slots; and
a clamp mounted on said holder for attaching said holder to a stable support.

2. The device of claim 1 wherein each of said slots has a generally key-hole shape.

3. The device of claim 2 wherein each slot includes:
a generally circular securing portion having a diameter substantially equal to or slightly greater than a diameter of a neck of a vial to be inserted therein;
angled surfaces converging towards said securing portion; and
shoulders separating said angled surfaces from said securing portion, said shoulders being spaced apart a distance less than a diameter of a neck of a vial to be inserted therein.

4. The device of claim 1 wherein the holder is constructed of a transparent material.

5. The device of claim 1 wherein said holder comprises:
a base to which said attachment device is secured;
a holding portion containing said slots, said holding portion being disposed at an angle with respect to said base.

6. The device of claim 1 wherein said clamp may be removably secured to supports at different locations and having different orientations and thicknesses.

7. The device of claim 6, wherein said clamp comprises two opposed, generally parallel plates and a shaft threadably mounted on one of said plates, said shaft being manually rotatable at a proximal end with respect to said one of said plates to adjust an axial position at a distal end of said shaft with respect to the other of said plates.

8. A device for holding a vial for use with a hypodermic needle, said device comprising:
a holder for restraining a plurality of vials of different sizes and lengths in a snap-fit relationship about a neck of each vial; and
a clamp attached to said holder for securing said holder to a stable support, said clamp being adjustable to accommodate supports of different sizes and being manually operable to permit the holder to be removed from one support and attached to another support.

9. The device as recited in claim 8, wherein each vial is unrestrained except for the snap-fit relationship between the holder and a neck of a vial.

10. The device as recited in claim 8, wherein the clamp comprises:
a first plate spaced from and generally parallel to a second plate;
a bracket connecting said first plate to said second plate;
a threaded shaft threadably mounted on one of said first plate and said second plate; and
a handle disposed on a proximal end of said shaft spaced from said selected one of said first plate and said second plate, said handle permitting rotation of said shaft to move said shaft axially to adjust a distance between a distal end of said shaft and the other of said one of said first and said second plate.

11. A method for restraining a plurality of vials of medication having different sizes for withdrawal of medication therefrom using a hypodermic needle, the method comprising:
providing a holder having a plurality of slots for restraining a plurality of vials of different sizes;
holding each vial in a snap-fit relationship about a neck of the vial; and
clamping the holder to a desired, stable support utilizing a removable, manually operated clamp.

12. The method of claim 1 wherein said holding step comprises:
inserting each vial into a slot having a securing portion with a diameter of approximately a same size as a diameter of a neck of that vial;
sliding the neck of that vial down the slot toward spaced shoulders having a normal spacing less than a diameter of the neck of that vial; and
urging the neck of that vial past the shoulders and into the securing portion.
